(19) United States
(12) Patent Application Publication
(10) Pub. No.: US 2015/0262049 A1
(43) Pub. Date: Sep. 17, 2015

(54) IMAGE OUTPUT SYSTEM AND IMAGE FORMING APPARATUS

(71) Applicant: SHARP KABUSHIKI KAISHA, Osaka-shi, Osaka (JP)

(72) Inventor: Shinichi Kawano, Osaka-shi (JP)

(73) Assignee: SHARP KABUSHIKI KAISHA, Osaka-shi, Osaka (JP)

(21) Appl. No.: 14/435,207

(22) PCT Filed: Oct. 11, 2013
(86) PCT No.: PCT/JP2013/077833

§ 371 Date: Apr. 13, 2015

(30) Foreign Application Priority Data
Oct. 17, 2012 (JP) 2012-230101

(51) Int. Cl. G06K 15/00; B42B 2/02

(52) U.S. Cl. CPC G06K 15/404; B42B 2/02

(57) ABSTRACT

An image output system is configured by including an image forming apparatus provided with a print engine that performs a saddle stitch printing, a stapling portion that performs a saddle stitching process and a cutting portion that cuts an end portion of printed matter, and an information processing apparatus having a function of instructing an outputting process to the image forming apparatus. The print engine has a function of performing a top/bottom borderless printing, the cutting portion has a function of cutting one side as a fore edge side of the printed matter subjected to the saddle stitching process, and the image forming apparatus cuts the one side as the fore edge side of the printed matter subjected to the saddle stitching process after the top/bottom borderless printing, in response to instructions from the information processing apparatus.

### TECHNICAL FIELD

The present invention relates to an image output system and an image forming apparatus, and in particular relates to an image output system and an image forming apparatus that are configured to perform a saddle stitch printing and a cutting process according to a saddle stitching process.

### BACKGROUND ART

In recent years, with the spread of an information processing apparatus (personal computer), an image outputting apparatus which performs output processing of image data transmitted from the information processing apparatus has become widely used. As the image outputting apparatus, there is a printer which has only a printing function, as well as a multi-functional printer which has, in addition to the printing function, data transmission functions such as a scanner function, a Fax transmission function, and an E-mail transmission function, an MFP (Multi-Functional Peripheral), and the like.

These image outputting apparatuses are connected to a network such as a LAN in a wired or wireless manner in many cases, and at an office or the like, a plurality of image outputting apparatuses are disposed at a plurality of places.

A user is also able to select an image outputting apparatus to use in consideration of disposed places and functions provided in the image outputting apparatuses, to perform, for example, a saddle stitch printing in which folding in half is performed for stapling at two central sites.

As a conventional technology, for example, image forming apparatuses in which book printing is performed and three sides are cut to thereby perform borderless printing (see Patent Document 1), and in which borderless printing is performed for end portions in a sheet width direction and a tip end and a rear end in a sheet conveyance direction are cut to thereby perform borderless printing (refer to Patent Literature 2) are disclosed.

According to them, it is possible to perform a borderless saddle stitch printing.

### PRIOR ART DOCUMENTS

### Patent Documents

Patent Document 1: Japanese Patent Application Laid-open No. 2009-128439

Patent Document 2: Japanese Patent Application Laid-open No. 2007-136943

### SUMMARY OF INVENTION

### Problem to be Solved by the Invention

In the Patent Document 1, however, since blank spaces of the three sides are cut, a mechanism for cutting becomes complicated or it takes long time because of many cutting sites, and further a dedicated option for cutting is required in some cases. In addition, in Patent Document 2, it is necessary to cut blank spaces of two sides.

The present invention has been made in view of above conventional problems, and aims to provide an image output system and an image forming apparatus that are capable of realizing a saddle stitched booklet by borderless printing and that allow to shorten a cutting time by cutting one side without making a mechanism for cutting complicated.

### Means for Solving the Problems

An image output system and an image forming apparatus according to the present invention for solving the problems described above are as follows.

The present invention provides an image output system configured by including:

an image forming apparatus comprising:
a printing portion that performs a saddle stitch printing for a recording medium;
a saddle stitch processing portion that performs a saddle stitching process for the recording medium; and
a cutting portion that cuts an end portion of the recording medium; and

an information processing apparatus having a function of instructing an outputting process to the image forming apparatus, wherein

a function of performing a top/bottom borderless printing is included as a function of the printing portion,

a function of cutting one side as a fore edge side of the recording medium subjected to the saddle stitching process is included as a function of the cutting portion, and

the image forming apparatus cuts the one side as the fore edge side of the recording medium subjected to the saddle stitching process after a top/bottom borderless printing, in response to an instruction from the information processing apparatus.

Moreover, in the present invention, it is preferable that the top/bottom borderless printing is that a print job in which printing is performed with a printing area in a top-bottom direction having a size larger than the recording medium, is generated by the information processing apparatus, and a printing processing is executed based on the print job by the image forming apparatus.

Moreover, in the present invention, it is preferable that the top/bottom borderless printing is that a print job in which printing is performed by eliminating a blank space between two images, which is formed in a center, when the saddle stitch printing is performed with a 2-up printing, is generated by the information processing apparatus, and a printing process is executed based on the print job by the image forming apparatus.

Moreover, in the present invention, it is preferable that the top/bottom borderless printing is that a print job in which printing is performed with a size in a left-and-right direction larger than a blank space between two images, which is formed in a center, when the saddle stitch printing is performed with a 2-up printing, is generated by the information processing apparatus, and a printing process is executed based on the print job by the image forming apparatus.

Moreover, the present invention provides an image forming apparatus comprising:

a printing portion that performs a saddle stitch printing for a recording medium,

a saddle stitch processing portion that performs a saddle stitching process for the recording medium,

a cutting portion that cuts an end portion of the recording medium, and

a control portion that performs control so that a cutting process is performed according to the saddle stitch printing or the saddle stitching process, wherein

a function of performing a top/bottom borderless printing is included as a function of the printing portion,

a function of cutting one side as a fore edge side of the recording medium subjected to the saddle stitching process is included as a function of the cutting portion, and

the control portion performs control so that the one side as the fore edge side of the recording medium subjected to the saddle stitching process after the top/bottom borderless printing, is cut.

### Advantages of Invention

According to the image output system of the present invention, an image output system configured by including:

an image forming apparatus comprising:
a printing portion that performs a saddle stitch printing for a recording medium;
a saddle stitch processing portion that performs a saddle stitching process for the recording medium; and
a cutting portion that cuts an end portion of the recording medium; and

an information processing apparatus having a function of instructing an outputting process to the image forming apparatus, wherein

a function of performing a top/bottom borderless printing is included as a function of the printing portion,

a function of cutting one side as a fore edge side of the recording medium subjected to the saddle stitching process is included as a function of the cutting portion, and

the image forming apparatus cuts the one side as the fore edge side of the recording medium subjected to the saddle stitching process after a top/bottom borderless printing, in response to an instruction from the information processing apparatus, thus making it possible to perform a borderless printing just by cutting only one side of the recording medium. This makes it possible to realize a saddle stitched booklet by the borderless printing which allows to shorten a cutting time without making a mechanism for cutting complicated.

Moreover, according to the image forming apparatus of the present invention, an image forming apparatus comprising:

a printing portion that performs a saddle stitch printing for a recording medium,

a saddle stitch processing portion that performs a saddle stitching process for the recording medium,

a cutting portion that cuts an end portion of the recording medium, and

a control portion that performs control so that a cutting process is performed according to the saddle stitch printing or the saddle stitching process, wherein

a function of performing a top/bottom borderless printing is included as a function of the printing portion,

a function of cutting one side as a fore edge side of the recording medium subjected to the saddle stitching process is included as a function of the cutting portion, and

the control portion performs control so that the one side as the fore edge side of the recording medium subjected to the saddle stitching process after the top/bottom borderless printing, is cut, thus making it possible to perform a borderless printing just by cutting only one side of the recording medium. This makes it possible to realize a saddle stitched booklet by the borderless printing which allows to shorten a cutting time without making a mechanism for cutting complicated.

### BRIEF DESCRIPTION OF DRAWINGS

FIG. 1 is a schematic explanatory view showing a connection state of an information processing apparatus and an image forming apparatus which constitute an image output system according to an embodiment of the present invention.

FIG. 2 is an explanatory view showing configurations of the information processing apparatus and the image forming apparatus which constitute the image output system with a block diagram.

FIG. 3 is an explanatory view showing one example of the configuration of the image forming apparatus which constitutes the image output system.

FIG. 4 is an explanatory view showing a schematic configuration of a post-processing apparatus installed in the image forming apparatus.

FIG. 5 (a) is an explanatory view showing a state where printed matter is reserved in a fold processing portion of the post-processing apparatus, and (b) is an explanatory view showing an action that the printed matter is folded in the folding processing portion.

FIG. 6 is an explanatory view showing a relation between the number of sheets and pages when the printed matter is subjected to a saddle stitching process in the image forming apparatus.

FIG. 7 show states of input images when a top/bottom borderless printing is performed in a saddle stitch printing by the image forming apparatus, in which (a) is an explanatory view showing a state where a printing area is larger than a sheet size and there is a gap between images of two images in a 2-up printing, (b) is an explanatory view showing a state where the printing area is larger than the sheet size and there is no space between the two images in the 2-up printing, and (c) is an explanatory view showing a state where upper and lower parts exceeding the printing area are not output in a state where there is no space between the two images in the 2-up printing.

FIG. 8 is an explanatory view showing one example of a display screen for performing a printing setting in the information processing apparatus.

FIG. 9 is an explanatory view showing one example of a display screen for performing a cutting setting in the information processing apparatus.

FIG. 10 is an explanatory view showing a schematic configuration of a cutting portion in the post-processing apparatus of the present embodiment.

FIG. 11 (a) is a side cross section showing a state where a fore edge side of printed matter subjected to saddle stitching process is cut by the cutting portion, and (b) is an X-arrow view of (a).

FIG. 12 is a flowchart that generation and transmission of a print job are performed by the information processing apparatus of the image output system of the present embodiment.

FIG. 13 is a flowchart that image formation is performed by the image forming apparatus of the image output system of the present embodiment.

FIG. 14 is a flowchart that the saddle stitch borderless printing is performed by the image forming apparatus of the image output system of the present embodiment.

FIG. 15 is an explanatory view showing a cutting position in a trimmer unit of the image forming apparatus of the present embodiment.

FIG. 16 is an explanatory view showing a relation among an image, a sheet and a cutting width in the saddle stitch printing by the image forming apparatus.

### MODE FOR CARRYING OUT THE INVENTION

Modes for carrying out an image output system of the present invention will be described herein below with reference to drawings.

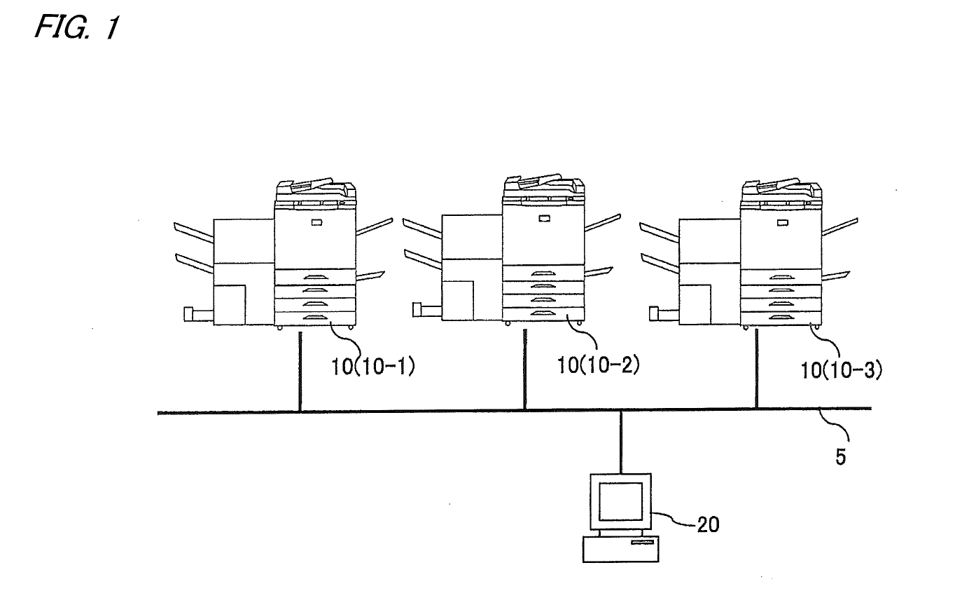

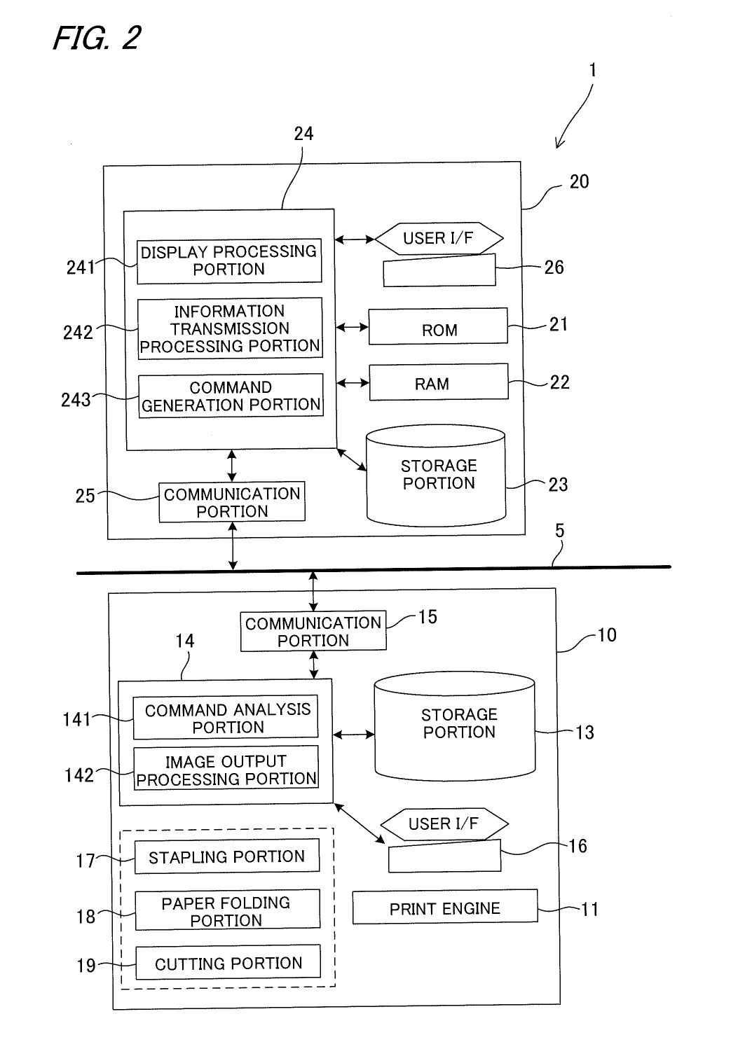

FIG. 1 shows one example of the modes for carrying out the invention, and is the schematic explanatory view showing a connection state of the information processing apparatus and the image forming apparatus which constitute the image output system according to the embodiment of the present invention, and FIG. 2 is the explanatory view showing configurations of the information processing apparatus and the image forming apparatus which constitute the image output system with a block diagram.

As shown in FIG. 1, the image output system 1 according to the present embodiment is configured by including an image forming apparatus 10 that performs a print-and-output process; and an information processing apparatus 20 that has a function of instructing an output process to the image forming apparatus 10. Characteristic configurations of the image output system according to the present invention are adopted to the image output system.

In the image output system 1 of the present embodiment, as shown in FIG. 1, the information processing apparatus 20 and the image forming apparatuses 10 (10-1 to 10-3 . . . 10-n) are connected via a network 5 such as the Internet or the intranet.

The network 5 is an IP network or the like such as the intranet/the Internet including a LAN, a wireless LAN, WiMAX, PLC, and c.link, and is also able to be connected to an external network.

The image forming apparatus 10 is an image forming apparatus that has at least a printing function, including a printer, a printer with a scanner function, a multi-functional printer, an MFP or the like.

The information processing apparatus 20 is an information processing apparatus such as an information processing apparatus/AT compatible machine and a MAC-standard machine, and may be a terminal such as a portable terminal including a PDA or the like. A plurality of information processing apparatuses 20 each of which has the same configuration and is connected to the network 5 may exist.

Next, description will be given for a characteristic configuration of the image output system 1 of the present embodiment.

The image output system 1 is characterized in that borderless printing is realized by cutting one side as a fore edge side of a recording medium which is subjected to a saddle stitching process after top/bottom border less printing in the image forming apparatus 10 in response to instructions from the information processing apparatus 20.

As shown in FIG. 2, the information processing apparatus 20 is configured by mainly including a ROM 21, a RAM 22, a storage portion 23, a CPU (control portion) 24, a communication portion 25, and a user interface 26.

The storage portion 23 is a memory configured by an HDD or the like.

The CPU 24 functions as the control portion and is configured to execute a program stored in the ROM 21 and the RAM 22 and uses the RAM 22 as a working area.

The CPU 24 is provided with a display processing portion 241, an information transmission processing portion 242, a command generation portion (command generation means) 243.

The command generation portion 243 generates a print job for performing output processing by the image forming apparatus 10. The information transmission processing portion 242 transmits the print job to the image forming apparatus 10.

The communication portion 25 transmits the print job which is generated by the command generation portion 243 to the image forming apparatus 10 via the network 5. For the transmission of the print job, an LPR (Line Printer daemon protocol), an FTP (File Transfer Protocol) or the like is usable.

The user interface 26 is configured by a display device, and an instruction input device such as a keyboard or a mouse, which are not shown in drawings.

In the present embodiment, the information processing apparatus 20 transmits the print job which is generated by the command generation portion 243 from the communication portion 25 through the information transmission processing portion 28 to the image forming apparatus 10 which performs the printing process.

The image forming apparatus 10 is, as shown in FIG. 2, configured by mainly including a print engine (printing portion) 11, a storage portion 13, a CPU (control portion) 14, a communication portion 15, a user interface 16, a stapling portion (saddle stitch processing portion) 17, a paper folding portion (saddle stitch processing portion) 18, and a cutting portion 19.

In the present embodiment, the image forming apparatus 10 is configured to, for printed matter which is output with top/bottom borderless printing of a saddle stitch printing in the print engine 11, perform the saddle stitching process for performing a stapling process at two central sites of the printed matter and then performing folding in the stapling portion 17 and the paper folding portion 18, and cut one side as a fore edge side of the printed matter in the cutting portion 19.

The storage portion 13 is a memory configured by an HDD or the like.

The CPU 14 functions as the control portion and is configured to execute a program stored in a ROM and a RAM which are not shown in drawings and uses the RAM as a working area.

The CPU 14 is provided with a command analysis portion 141 and an image output processing portion 142.

The command analysis portion 141 analyzes a command of a print job received from the information processing apparatus 20 and judges processing for a finished document or the like.

The image output processing portion 142 performs an output process based on a setting of the print job from the information processing apparatus 20, which is analyzed at the command analysis portion 141.

Further, the image output processing portion 142 performs output to the print engine 11 based on information of the print job from the information processing apparatus 20, which is analyzed at the command analysis portion 141.

The communication portion 15 receives the print job transmitted from the information processing apparatus 20 via the network 5.

The user interface 16 is configured by a display device, and an instruction input device such as a keyboard or a mouse, which are not shown in drawings.

Here, description will be given for a schematic configuration of the image forming apparatus 10.

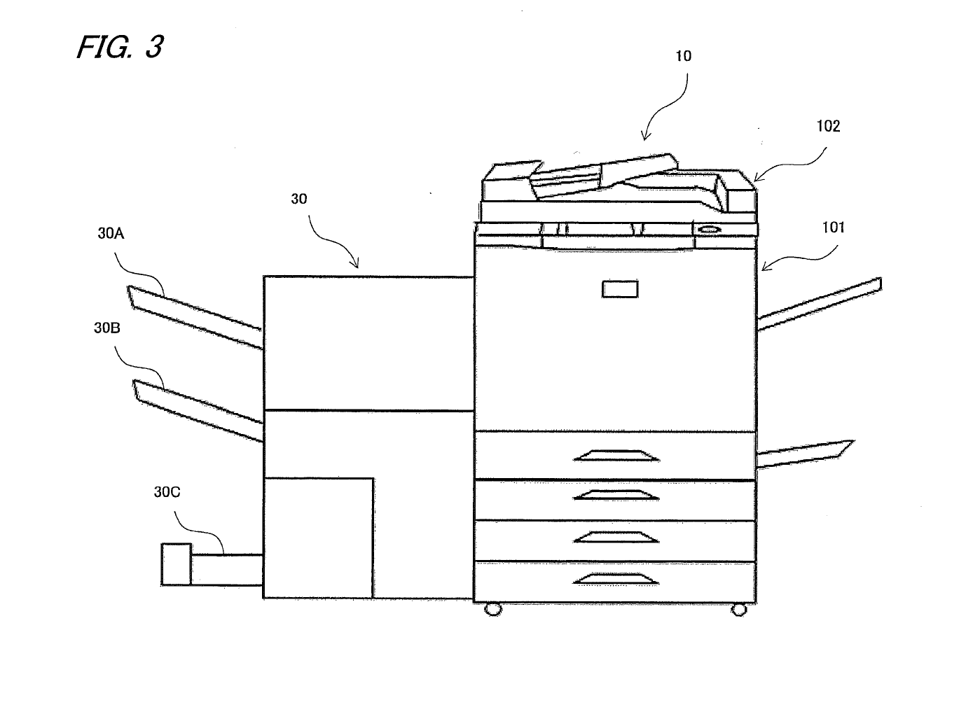

FIG. 3 is an explanatory view showing one example of the configuration of the image forming apparatus which constitutes the image output system of the present embodiment.

In the image forming apparatus 10 of the image output system 1 of the present embodiment, as shown in FIG. 3, an image reading portion 102 is mounted on a top part of an apparatus main body 101 and a post-processing apparatus 30 is arranged in a side part of the apparatus main body 101.

In the present embodiment, post-processing is to include the stapling process, paper folding processing and cutting processing.

The post-processing apparatus 30 includes paper output trays 30A, 30B and 30C so as to allow paper output in a sorting manner in accordance with a completed state of printed matter which is output.

Printed matter which is not subjected to post-processing is output to the paper output tray 30A. Printed matter which is subjected to the stapling process and not subjected to a saddle stitch folding is output to the paper output tray 30B. Printed matter which is subjected to the saddle stitch folding after the stapling process is output to the paper output tray 30C.

Next, description will be given specifically for conveyance of printed matter according to post-processing in the post-processing apparatus 30 of the present embodiment with reference to drawings.

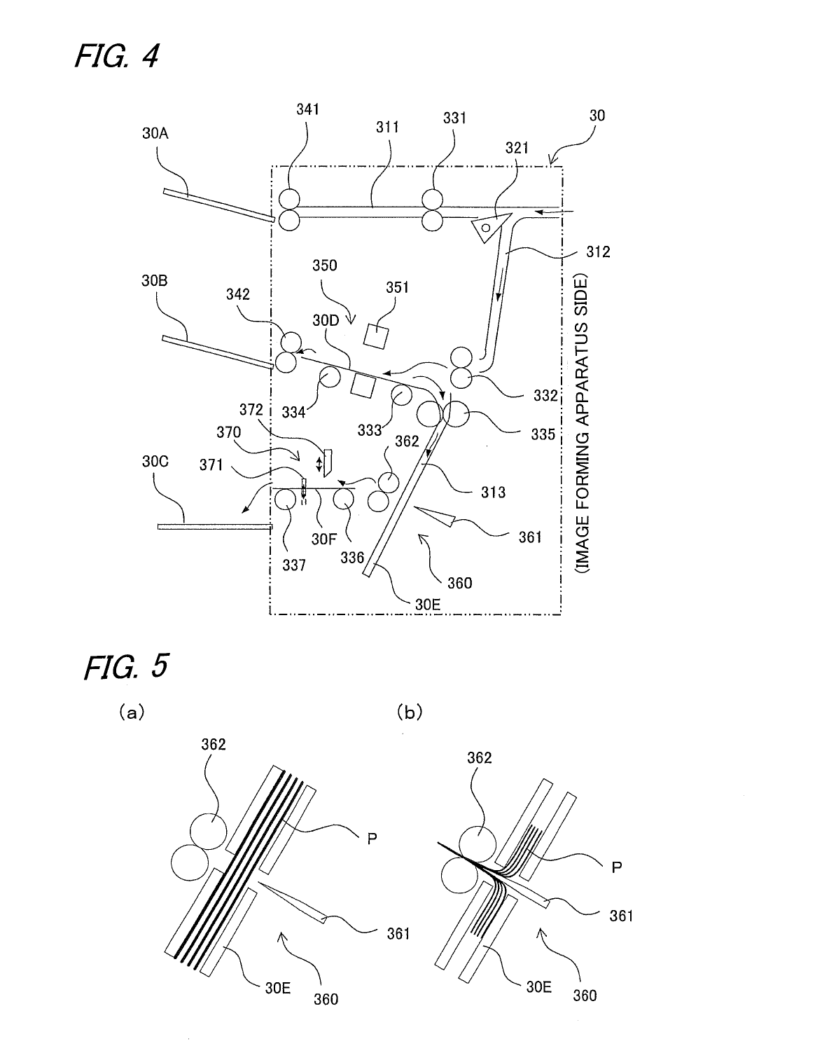

FIG. 4 is an explanatory view showing a schematic configuration of the post-processing apparatus installed in the image forming apparatus of the present embodiment, FIG. 5(a) is an explanatory view showing a state where printed matter is reserved in a folding processing portion of the post-processing apparatus, and FIG. 5 (b) is an explanatory view showing an action that the printed matter is folded in the folding processing portion.

First, description will be given for a case where post-processing is not set to printed matter.

The printed matter conveyed from the image forming apparatus 10 side to the post-processing apparatus 30 is, as shown in FIG. 4, guided by a conveyance direction switching gate 321, conveyed to a first sheet conveyance path 311 by conveyance rollers 331, and discharge to the paper delivery tray 30A by a paper delivery rollers 341.

Next, description will be given for a case where the stapling process is set to printed matter.

Printed matter which is conveyed from the image forming apparatus side is, as shown in FIG. 4, guided to a second sheet conveyance path 312 by the conveyance direction switching gate 321, conveyed to a stapling tray 30D by conveyance rollers 332, and is subjected to a stapling process by a stapler 351 in a stapling unit 350.

When the saddle stitching process is set to the printed matter, the stapling process is applied to a center part of the printed matter.

Then, the printed matter subjected to the stapling process by the stapler 351, when the saddle stitch folding is not set, is conveyed by conveyance rollers 333 and 334 and discharged to the paper delivery tray 30B by paper delivery rollers 342.

On the other hand, when the saddle stitch folding is set, the printed matter subjected to the stapling process by the stapler 351 is returned by the conveyance rollers 333 and 334, guided to a third sheet conveyance path 313 by conveyance rollers 335, and conveyed to a folding processing unit 360.

The fold processing unit 360 is configured by including a fold processing tray 30E, a folding member 361 and folding rollers 362 as shown in FIGS. 5(a) and (b).

A reference sign P indicates a plurality of pieces of printed matter reserved in the fold processing tray 30E.

The fold processing tray 30E is configured so that a plurality of sheets of the printed matter which are conveyed are able to be reserved.

The folding member 361 and the folding roller 362 are arranged at positions in which the holding member and the folding rollers are facing across the fold processing tray 30E.

The folding rollers 362 are configured by a pair of rollers. The folding member 361 is configured so as to be able to project toward between rollers of the folding rollers 362 (a nip position).

The printed matter conveyed to the folding processing unit 360, as shown in FIGS. 5(a) and (b), are reserved in the fold processing tray 30E until a predetermined number of sheets, and then, are pressed by the folding member 361 at a folding position of the center part of the printed matter, further pressed into between the rollers of the folding rollers 362 by the folding member 361, and while being subjected to the saddle stitch folding being compressed by the folding rollers 362, the printed matter are conveyed to a trimmer unit (cutting portion) 370 as shown in FIG. 4.

The printed matter is then conveyed onto a cutting tray 30F by conveyance rollers 336 and 337 and positioned by a positioning portion 371, and one end side of the printed matter is subjected to a fore edge cutting by a trimmer cutter 372 at a predetermined position. Then, the printed matter which has been cut are conveyed by the conveyance rollers 336 and 337 and discharged to the paper delivery tray 30C.

Here, description will be given for a relation of the number of sheets and pages of printed matter subjected to the saddle stitching process.

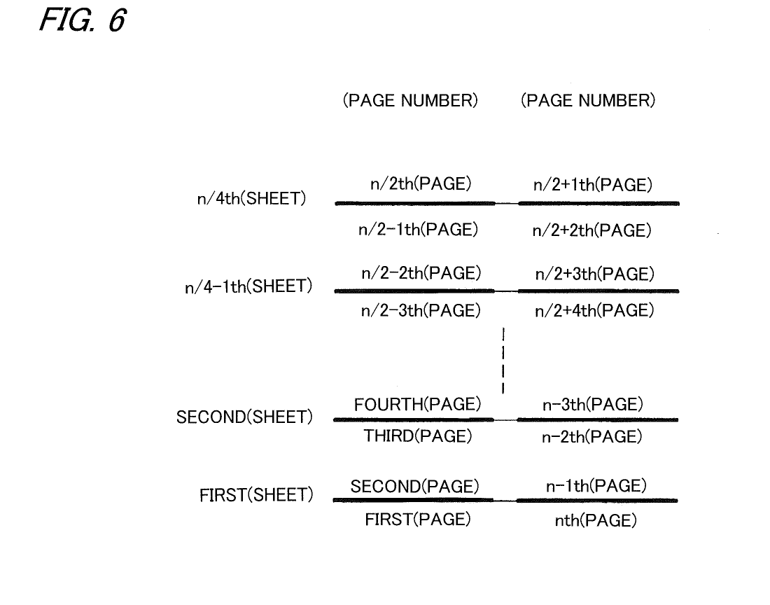

FIG. 6 is an explanatory view showing a relation of the number of sheets and pages when printed matter is subjected to the saddle stitching process in the image forming apparatus of the present embodiment.

In a case where printed matter subjected to a 2-UP and double-sided printing is configured by a plurality of sheets and subjected to the saddle stitching process, when pages of images in printing data have a first page to an nth page as shown in FIG. 6, the printed matter has n/4 sheets.

Then, first, second, n−1th and nth pages are printed on a first sheet with the 2-up and double-sided printing, and third, fourth, n−2th and n−3th pages are printed on a second sheet.

In this manner, n/2−2th, n/2−3th, n/2+3th and n/2+4th pages are printed on an n/4−1th sheet, and n/2th, n/2−1th, n/2+1th and n/2+2th pages are printed on a last n/4th sheet.

Next, description will be given for output processing by top/bottom borderless printing in the saddle stitch printing which is executed by the image forming apparatus 10 in the image output system 1 of the present embodiment.

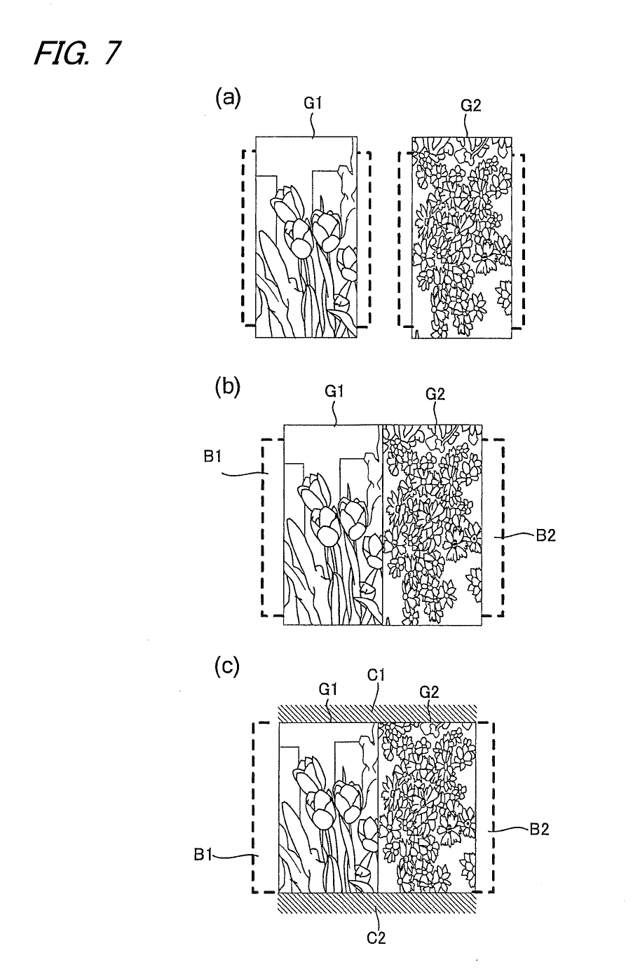

FIG. 7 show states of input images when top/bottom borderless printing is performed in the saddle stitch printing by the image forming apparatus of the present embodiment, in which (a) is an explanatory view showing a state where a printing area is larger than a sheet size and there is a gap between two images in 2-up printing, (b) is an explanatory view showing a state where the printing area is larger than the sheet size and there is no space between the two images in 2-up printing, and (c) is an explanatory view showing a state where upper and lower parts exceeding the printing area are not output in a state where there is no space between the two images in 2-up printing.

When top/bottom borderless printing is performed in the saddle stitch printing of the 2-up printing by the image forming apparatus 10 in the image output system 1 of the present embodiment, output processing is performed in a state where a printing area in which an image is printed is formed to be larger than a sheet size in a vertical direction and a gap between two images is eliminated.

Specifically, as shown in FIG. 7(a), when images G1 and G2 are formed by setting blank spaces (for example, 4.2 mm or more) on right and left of each of the images G1 and G2 in normal 2-up printing, a gap is formed between the two images.

Then, as shown in FIG. 7(b), when a blank space B1 on a left side of the left-side image G1 is set to be twice or more of the other side (for example, 8.4 mm or more) and a blank space B2 on a right side of the right-side image G2 is similarly set to be twice or more of the other side (for example, 8.4 mm or more) in a state where the two images G1 and G2 are arranged side by side, it is possible to perform 2-up printing without forming a gap between the two images (center part).

Further, by performing output in a state that the printing area in which the images G1 and G2 are printed, is formed larger than the sheet size in the vertical direction, it is possible to realize top/bottom borderless printing with a full of the sheet size in which parts C1 and C2 beyond the sheet size are not output as shown in FIG. 7(c).

Here, description will be given for a reason why the blank spaces B1 and B2 are set in right and left of a sheet.

In an electrophotographic system, it is necessary to perform control so that toner is not adhered to a tip end of a sheet in a sheet conveyance direction. In a case where toner is adhered to the tip end of the sheet, when the sheet after transfer passes through a process component such as a photosensitive member, a transfer belt or a fixing roller, due to adhering force of the toner which is adhered to the tip end of the sheet, the tip end of the sheet is possibly wound around the process component to cause paper jam.

For such a reason, the blank spaces B1 and B2 are set on right and left of the sheet.

Note that, when forming the blank space, at least any one of a tip end side and a rear end side in the sheet conveyance direction may be the blank space.

When the blank space is formed on one side of the sheet, images become non-symmetrical on both sides of a spread page, and therefore, in the case of a specification in which two images have different magnifications, etc., it is necessary to make consideration for a design. When blank spaces are formed on both sides of the sheet, such consideration becomes unnecessary.

Next, description will be given for a case where setting of top/bottom borderless printing is performed by a printer driver in the image output system 1 of the present embodiment.

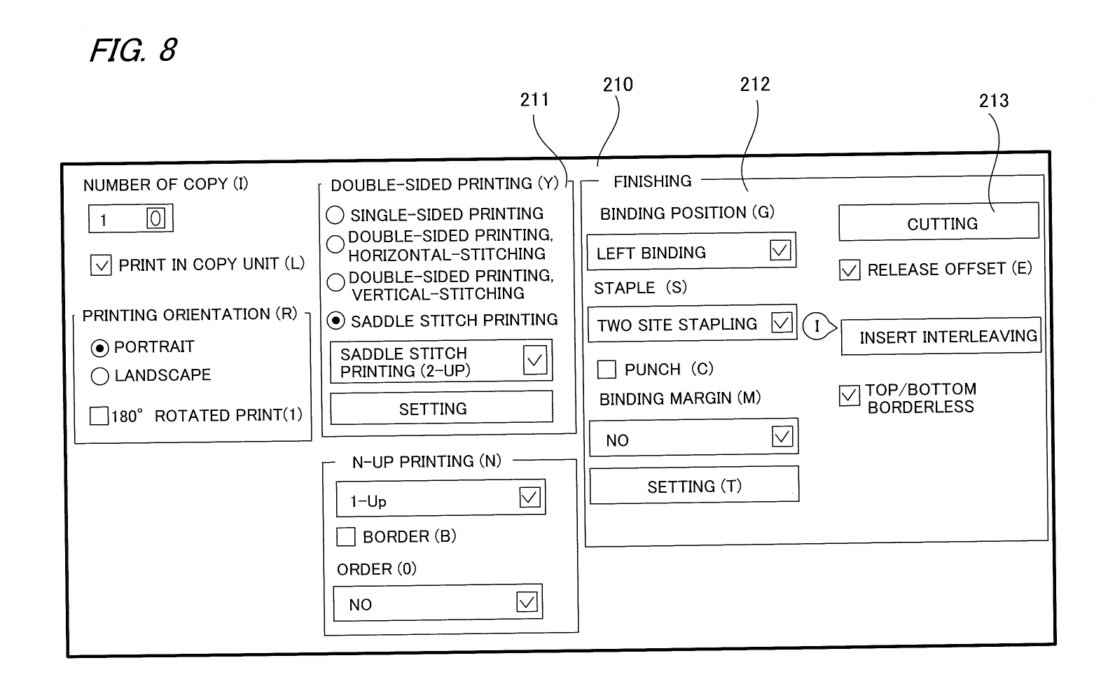

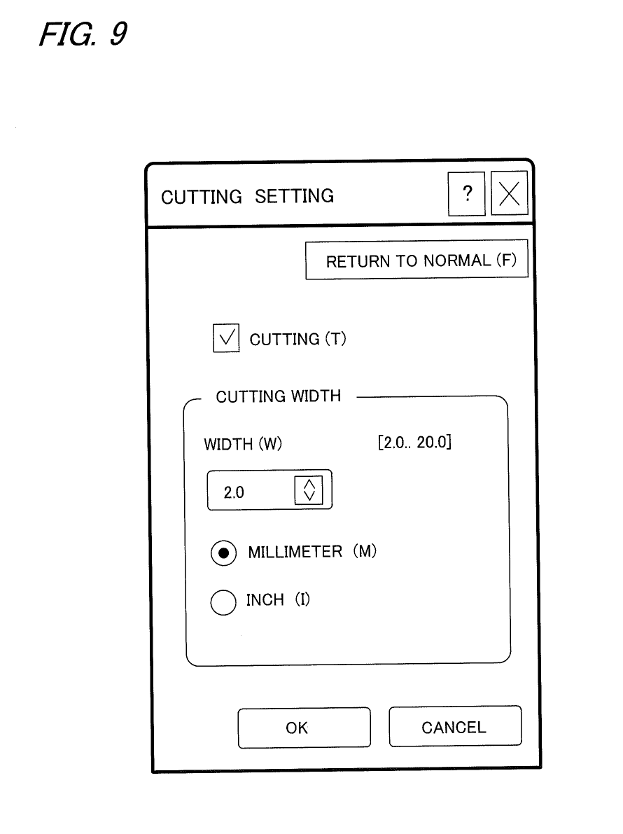

FIG. 8 is an explanatory view showing one example of a display screen for performing a printing setting in the information processing apparatus which constitutes the image output system of the present embodiment, and FIG. 9 is an explanatory view showing one example of a display screen for performing a cutting setting in the information processing apparatus.

When the printing setting is performed by the printer driver included in the information processing apparatus 20 in the image output system 1 of the present embodiment, as shown in FIG. 8, it is performed from a setting screen 210 which is displayed on a display portion (not shown in the figure) of the information processing apparatus 20.

In the present embodiment, as one example of the printing setting, the printing setting is performed by setting the saddle stitch printing (2-up) in a double-sided printing item 211, setting “left” to a binding edge and two sites to a staple, and selecting (checking) “top/bottom borderless” in an output item 212 among setting items.

Further, when cutting processing is set as post-processing, “cut” is selected in the output item 212, and a cutting setting screen 220 is displayed as shown in FIG. 9 to perform detailed setting for cutting. For example, when one side as a fore edge side of printed matter is cut, a cutting width is set on a screen in which a cutting width is set in the cutting setting screen 220.

By performing the setting of the post-processing as described above, when a sheet size of a document is A4, an output sheet size becomes A3, so that the printer driver passes a size that a printing area in a top-bottom direction is larger than A4 to an opened application, and data returned from the application to the printer driver also has a size larger than A4 regarding the top-bottom direction.

Then, for printing data generated by the information processing apparatus 20 as well, a print job like an image shown in FIG. 7(b) is generated.

The image forming apparatus 10 receiving the print job generated by the information processing apparatus 20 generates image data by eliminating a blank space of the center part between the two images and treating this eliminated blank space as right and left blank spaces as shown in FIG. 7(b).

Finally, since the size in the top-bottom direction is larger than a size of an A3-sheet as shown in FIG. 7(c), the printed matter in which the parts C1 and C2 beyond the sheet size are not printed is created.

Next, description will be given for processing for cutting one side as a fore edge side of printed matter subjected to the saddle stitching process in the image forming apparatus 10 with reference to drawings.

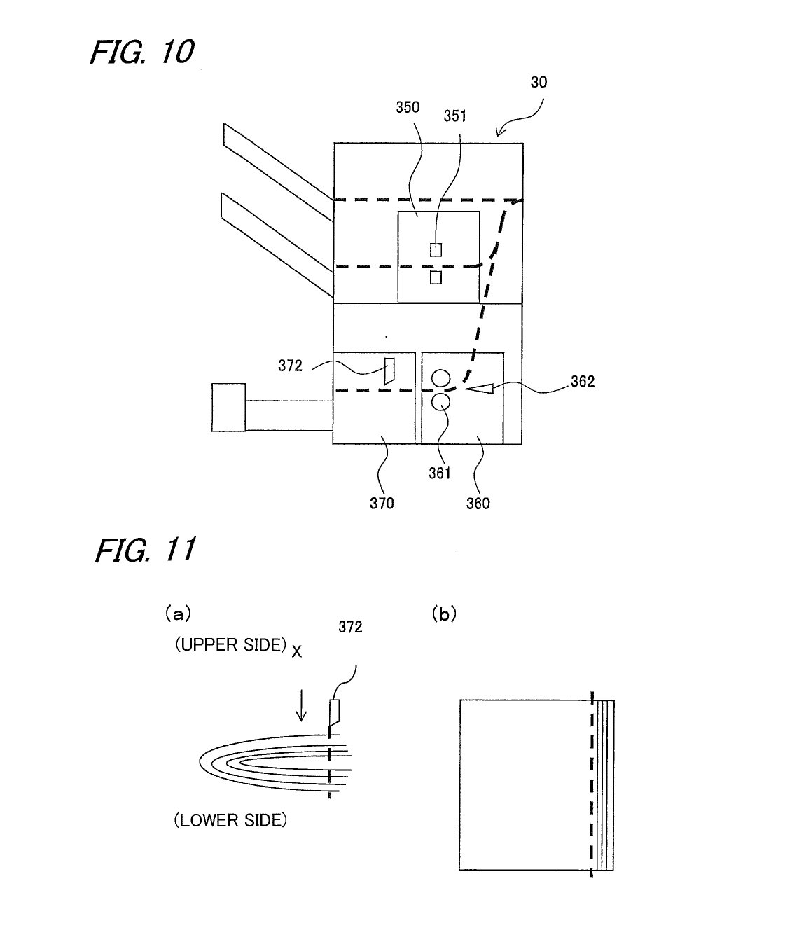

FIG. 10 is an explanatory view showing a schematic configuration of the cutting portion in the post-processing apparatus of the present embodiment, FIG. 11(a) is a side cross section showing a state where a fore edge side of printed matter subjected to the saddle stitching process is cut by the cutting portion, and (b) is an X-arrow view of (a).

In the present embodiment, for printed matter subjected to the saddle stitching process by applying staples at two sites in a center part of the printed matter after the saddle stitch printing, one side as a fore edge side is to be cut.

The post-processing apparatus 30 mounted in the image forming apparatus 10 includes, as shown in FIG. 10, the stapling unit 350, the folding processing unit 360, and the trimmer unit 370, and constitutes a saddle stitch finisher having a stapling function, a paper folding function, and a cutting function.

In the image forming apparatus 10, when the printed matter to which a layout by the saddle stitch printing is performed by the print engine 11 is conveyed to the post-processing apparatus 30 shown in FIG. 10, staples are applied at two sites on the center part of the printed matter in the stapling unit 350 and the printed matter is folded in half at the center in the folding processing unit 360.

Then, when the printed matter which is folded in half is conveyed to the trimmer unit 370, as shown in FIGS. 11(a) and (b), one site as the fore edge side of the printed matter is cut by the trimmer cutter 371.

Next, description will be given for processing for generating and transmitting a print job by using the printer driver in the information processing apparatus 20 of the image output system 1 of the present embodiment along a flowchart.

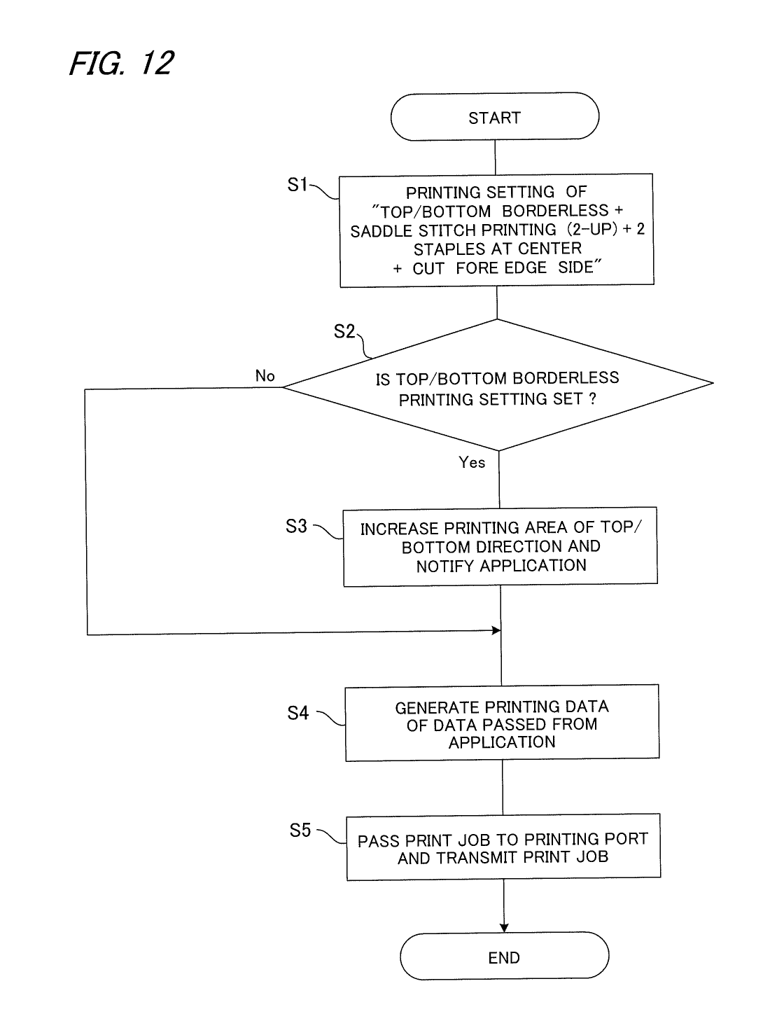

FIG. 12 is a flowchart that generation and transmission of the print job is performed by the information processing apparatus of the image output system of the present embodiment.

In the image output system 1 of the present embodiment, when a printing setting is performed, as shown in FIG. 12, the printing setting is performed that “top/bottom borderless+saddle stitching print (2-up print)”, “stapling process at two sites in a center part of printed matter” and “cutting a fore edge side” are performed by using the printer driver in the information processing apparatus 20 (step S1).

Then, it is judged whether or not top/bottom borderless printing is set (step S2).

When it is judged that the top/bottom borderless printing is set at step S2, instructions are given to an application to increase a printing area in a top-bottom direction (step S3), and printing data is generated in the command generation portion 243 based on data transmitted from the application (step S4).

On the other hand, when it is judged that the top/bottom borderless printing is not set at step S2, the procedure directly proceeds to step S4.

Then, a print job is passed to a printing port and the print job is transmitted to the image forming apparatus 10 (step S5).

In this manner, the print job is generated by the information processing apparatus 20 and the generated print job is transmitted to the image forming apparatus 10.

Next, description will be given for processing for eliminating a blank space in a center part of printed matter when the saddle stitch printing is performed in the image forming apparatus 10 of the image output system 1 of the present embodiment along a flowchart.

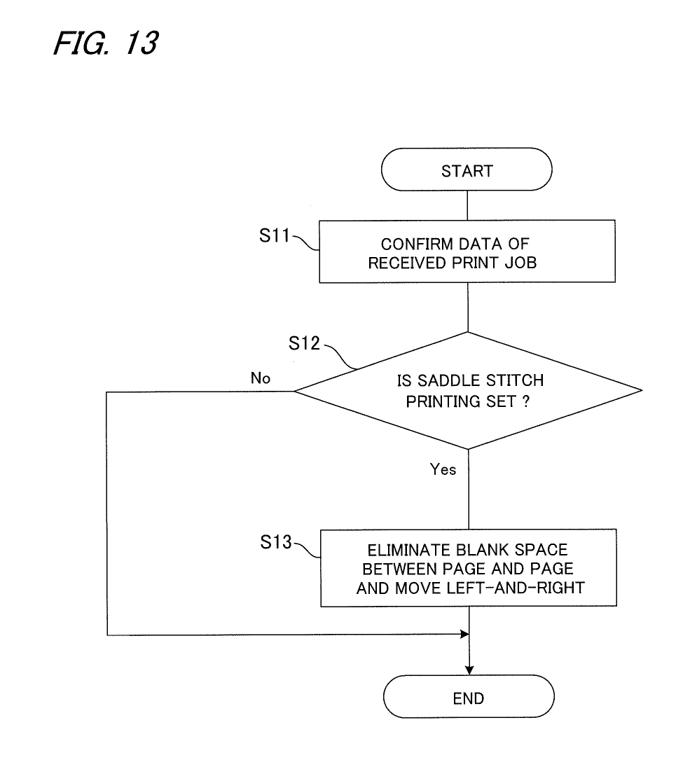

FIG. 13 is a flowchart that image formation is performed by the image forming apparatus of the image output system of the present embodiment.

In the image output system 1 of the present embodiment, when image formation is performed by the image forming apparatus 10 based on a print job transmitted from the information processing apparatus 20, as shown in FIG. 13, data of the print job received in the image forming apparatus 10 is confirmed by the command analysis portion 141 (step S11).

Then, it is judged whether or not the saddle stitch printing is set (step S12).

When it is judged that the saddle stitch printing is set at step S12, image formation is performed by moving images to be printed to the center part of a sheet to eliminate a blank space between the images (step S13).

On the other hand, when it is judged that the saddle stitch printing is not set at step S12, the step is finished as it is.

In this manner, it is possible to eliminate the blank space in the center part of the printed matter in the saddle stitch printing by the image forming apparatus 10.

Next, description will be given for a process for cutting a fore edge side of printed matter which has been subjected to the saddle stitching process after having performed the top/bottom borderless printing, in the image forming apparatus 10 of the image output system 1 of the present embodiment along a flowchart.

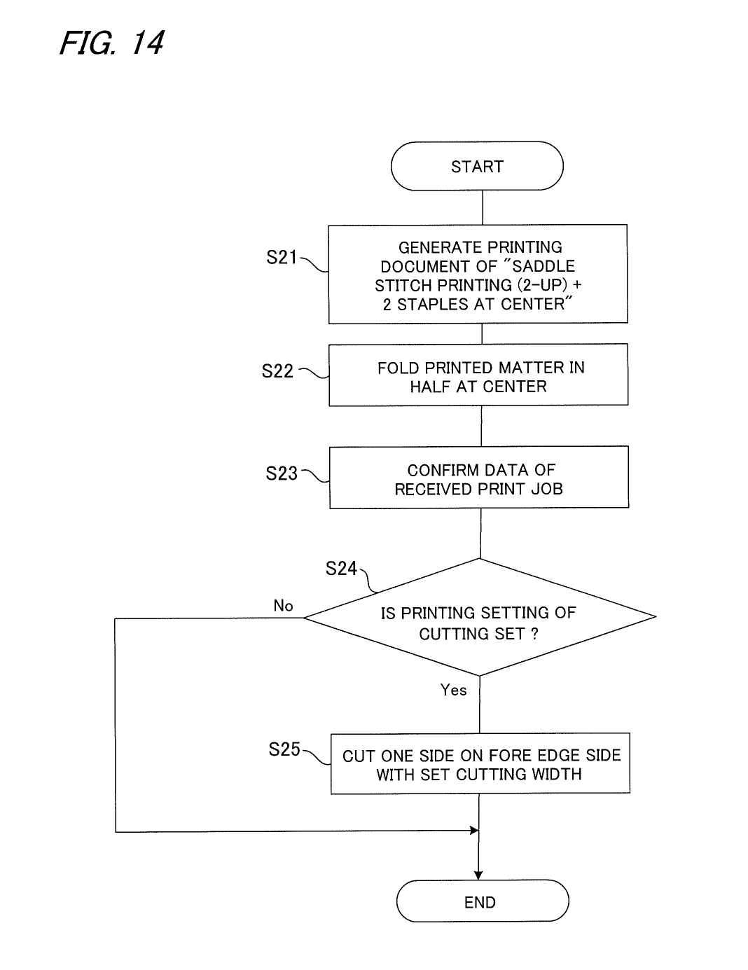

FIG. 14 is a flowchart that a saddle stitch borderless printing is performed by the image forming apparatus of the image output system of the present embodiment.

In the image output system 1 of the present embodiment, when the saddle stitch borderless printing is performed, as shown in FIG. 14, in the image forming apparatus 10, the top/bottom borderless saddle stitch printing (2-up printing) is performed by the print engine and printed matter in which the stapling process has been performed at two sites in a center part in the stapling unit 350 is generated (step S21).

Then, the printed matter is folded in half in the folding processing unit 360 (step S22). Data of a print job from the information processing apparatus 20 is then confirmed (step S23), and it is judged whether or not a cutting process for cutting one side as a fore edge side is set (step S24).

When it is judged that the cutting process for cutting one side as the fore edge side is set at step S24, one side as the fore edge side of the printed matter is cut with a cutting width which is set, in the trimmer unit 370 (step S25).

On the other hand, when it is judged that the cutting process for cutting one side as the fore edge side is not set at step S24, the step is finished as it is.

In this manner, by cutting one side as the fore edge side of the printed matter after performing the saddle stitching process by the image forming apparatus 10, it is possible to perform the saddle stitch borderless printing.

According to the present embodiment configured as above, in the image output system 1 configured by including the image forming apparatus 10 provided with the print engine 11 that performs the saddle stitch printing for a sheet, the stapling portion 17 that performs the saddle stitching process for the printed matter, and the cutting portion 19 that cuts an end portion of the printed matter, and the information processing apparatus 20 having a function of instructing an outputting process to the image forming apparatus 10; a function of performing the top/bottom borderless printing is included as a function of the print engine 11, a function of cutting one side as the fore edge side of the printed matter subjected to the saddle stitching process is included as a function of the cutting portion 19, and the image forming apparatus 10 cuts the one side as the fore edge side of the printed matter subjected to the saddle stitching process after the top/bottom borderless printing in response to instructions from the information processing apparatus 20, thus making it possible to perform the borderless printing just by cutting only one side of the printed matter with a simple configuration. This makes it possible to realize a saddle stitched booklet by the borderless printing which allows to shorten a cutting time without making a mechanism for cutting complicated.

Moreover, according to the present embodiment, the top/bottom borderless printing of the saddle stitch printing is performed so that a print job in which printing is performed with a printing area in a top-bottom direction having a size larger than a sheet size, is generated by the information processing apparatus 20 and the printing process is executed based on the print job by the image forming apparatus 10, thus making it possible to eliminate a blank space in the top-bottom direction easily.

Further, according to the present embodiment, the top/bottom borderless printing is performed so that a print job in which printing is performed by eliminating a blank space between two images, which is formed in a center, when the saddle stitch printing is performed with the 2-up printing, is generated by the information processing apparatus 20, and the printing process is executed based on the print job by the image forming apparatus 10, thus making it possible to perform the border less printing without a central blank space easily.

Furthermore, according to the present embodiment, the top/bottom borderless printing is performed so that a print job in which printing is performed with a size in a left-and-right direction larger than a blank space between two images, which is formed at a center, when the saddle stitch printing is performed with the 2-up printing, is generated by the information processing apparatus 20, and the printing process is executed based on the print job by the image forming apparatus 10, thus making it possible to increase a printing area in the left-and-right direction easily.

Moreover, according to the present embodiment, as the configuration of the image forming apparatus 10, when one side as the fore edge side of the printed matter is cut, a function of specifying a width to be cut, that is, the cutting setting screen 220 is displayed to perform detailed setting for cutting, thus making it possible to specify the width to be cut and finely adjust a size of the printed matter easily.

For example, by setting a void width in the sheet conveyance direction to a cutting width of the fore edge side as the cutting width of the printed matter, it is possible to set the cutting width correctly.

Description will be given below with reference to drawings.

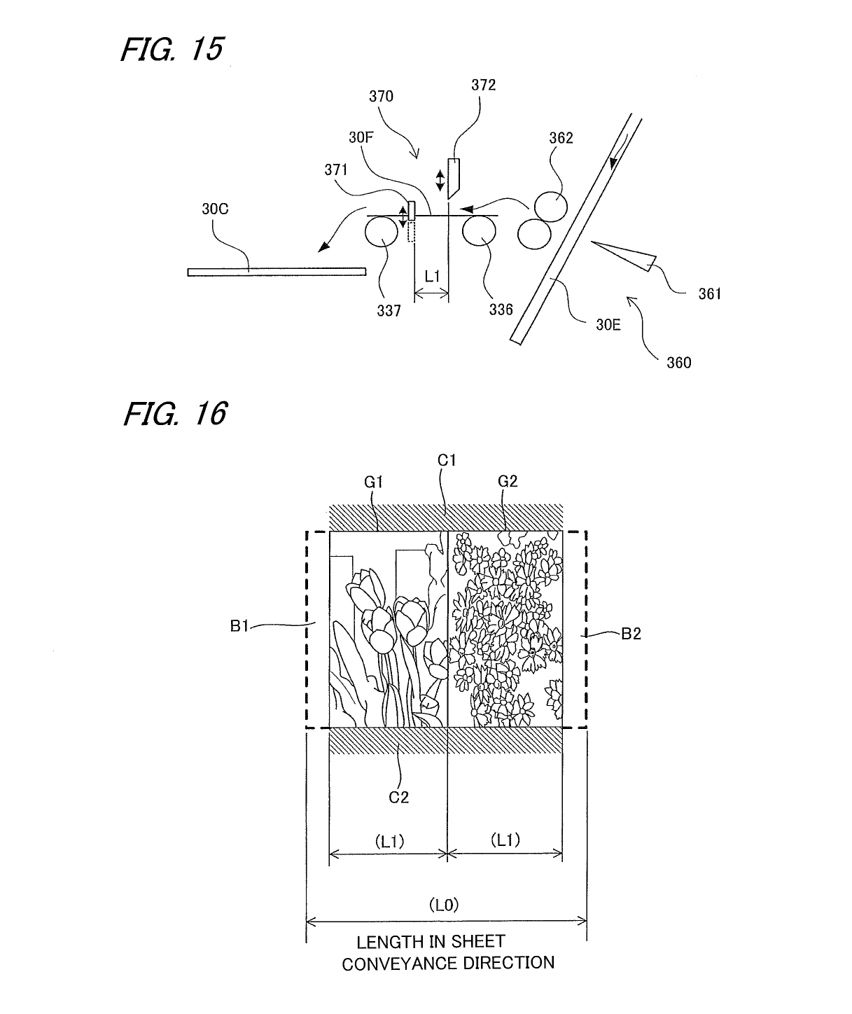

FIG. 15 is an explanatory view showing a cutting position in the trimmer unit of the image forming apparatus of the present embodiment, and FIG. 16 is an explanatory view showing a relation among an image, a sheet, and a cutting width in the saddle stitch printing by the image forming apparatus.

Specifically, when a distance between the positioning portion 371 and the trimmer cutter 372 is L1 as shown in FIG. 15, as shown in FIG. 16, a blank space B1 as a fore edge side of printed matter is regarded as being equal to B2, and a length obtained by deducting a length of the blank space B1 (B2) from ½ of a length L0 in the sheet conveyance direction is set as L1. If the blank spaces B1 and B2 are not equal, a larger value is set as the “blank space length”. At this time, the “cutting width” shown in FIG. 9 is matched with the “blank space length” described above.

With such a structure, it is possible to set the cutting width of the printed matter correctly, thus making it possible to realize a saddle stitched booklet without a blank space.

Note that, the present embodiment is configured so that top/bottom borderless printing is allowed in the printing portion, but further may be configured so as to restrict the number of sheets for successive printing of borderless pages.

Specifically, when the top/bottom borderless printing is performed as shown in FIG. 16, the parts C1 and C2 beyond the sheet size are formed, and therefore, toner of the parts C1 and C2 beyond the sheet size remains in a component to which toner of the print engine 11 is applied (for example, a photosensitive member or an intermediate transfer belt).

Though the remaining toner is normally removed by a cleaning function (for example, cleaning unit), when the top/bottom borderless printing is performed, a burden on the cleaning function is increased compared to the normal printing, so that the number of pages for which the top/bottom borderless printing is allowed may be restricted so as not to increase the burden excessively.

For example, the top/bottom borderless printing may be performed only for a front surface of a first sheet (a surface serving as a cover or a back cover) of the print job shown in FIG. 6. In this case, processing may be performed so as to perform image formation by enlarging printing areas in the top-bottom direction only in the first page and the nth page corresponding to the cover part of the first sheet of the print job at the processing step of step S3 in the flowchart shown in FIG. 12, and by moving images to be printed to a center part of the sheet to eliminate a blank space between images only in the first page and the nth page at the processing step of step S13 in the flowchart shown in FIG. 13. Other pages are not subjected to the processing of step S3 or step S13 (skipped).

With such a configuration, it is possible to suppress a quantity of toner (remaining toner) applied to an outer side of the sheet by the top/bottom borderless printing, thus making it possible to prevent the excessive burden from being put on the cleaning function which removes the remaining toner.

Moreover, the present embodiment is configured so that the saddle stitch borderless printing is easily performed by the image output system 1 configured by including the image forming apparatus 10 and the information processing apparatus 20 having a function of instructing an outputting process to the image forming apparatus 10, but the present invention is not limited to the configuration described above, and may be configured such that, for example, in an image forming apparatus provided with a control portion that performs control so as to perform the cutting process according to the saddle stitch printing and the saddle stitching process, the control portion performs control so that one side as a fore edge side of printed matter subjected to the saddle stitching process after the top/bottom borderless printing, is cut. With such a configuration, it is possible to perform the borderless printing just by cutting only one side of the printed matter with a simple configuration in the same manner as the image output system 1 of the embodiment described above. This makes it possible to realize a saddle stitched booklet by borderless printing which allows to shorten a cutting time without making a mechanism for cutting complicated.

As described above, the present invention should not be limited to the embodiment described above, and various changes can be made within the range specified in the scope of claims. That is, any embodiment obtained by combination of technical means modified as appropriate without departing from the spirit and scope of the present invention should be included in the technical scope of the present invention.

### DESCRIPTION OF REFERENCE NUMERALS

1 image output system
10 image forming apparatus
11 print engine (printing portion)
17 stapling portion (saddle stitch processing portion)
19 cutting portion
20 information processing apparatus
30 post-processing apparatus
141 command analysis portion
142 image output processing portion
243 command generation portion
350 stapling unit (saddle stitch processing portion)
360 folding processing unit (saddle stitch processing portion)
370 trimmer unit (cutting portion)
B1, B2 blank space
G1, G2 image

1. An image output system configured by including:
an image forming apparatus comprising:
a printing portion that performs a saddle stitch printing for a recording medium;
a saddle stitch processing portion that performs a saddle stitching process for the recording medium; and
a cutting portion that cuts an end portion of the recording medium; and
an information processing apparatus having a function of instructing an outputting process to the image forming apparatus,
wherein
the printing portion has a function of performing a top/bottom borderless printing,
the cutting portion has a function of cutting one side as a fore edge side of the recording medium subjected to the saddle stitching process, and
the image forming apparatus cuts the one side as the fore edge side of the recording medium subjected to the saddle stitching process after a top/bottom borderless printing, in response to an instruction from the information processing apparatus.

2. The image output system according to claim 1, wherein the top/bottom borderless printing is that
a print job in which printing is performed with a printing area in a top-bottom direction having an area larger than the recording medium, is generated by the information processing apparatus, and
a printing processing is executed based on the print job by the image forming apparatus.

3. The image output system according to claim 1, wherein the top/bottom borderless printing is that
a print job in which printing is performed by eliminating a blank space between two images, which is formed in a center, when the saddle stitch printing is performed with a 2-up printing, is generated by the information processing apparatus, and
a printing process is executed based on the print job by the image forming apparatus.

4. The image output system according to claim 1, wherein the top/bottom borderless printing is that
a print job in which printing is performed with a size in a left-and-right direction larger than a blank space between two images, which is formed in a center, when the saddle stitch printing is performed with a 2-up printing, is generated by the information processing apparatus, and
a printing process is executed based on the print job by the image forming apparatus.

5. An image forming apparatus comprising:
a printing portion that performs a saddle stitch printing for a recording medium,
a saddle stitch processing portion that performs a saddle stitching process for the recording medium,
a cutting portion that cuts an end portion of the recording medium, and
a control portion that performs control so that a cutting process is performed according to the saddle stitch printing or the saddle stitching process,
wherein
the printing portion has a function of performing a top/bottom borderless printing,
the cutting portion has a function of cutting one side as a fore edge side of the recording medium subjected to the saddle stitching process, and
the control portion performs control so that the one side as the fore edge side of the recording medium subjected to the saddle stitching process after the top/bottom borderless printing, is cut.
